(19) United States
(12) Patent Application Publication
(10) Pub. No.: US 2023/0152104 A1
(43) Pub. Date: May 18, 2023

(54) METHODS AND APPARATUSES FOR IMPLEMENTING INTEGRATED IMAGE SENSORS

(71) Applicant: Johnson Controls Tyco IP Holdings LLP, Milwaukee, WI (US)

(72) Inventors: Jason M. OUELLETTE, Sterling, MA (US); Gopal Paripally, North Andover, MA (US)

(21) Appl. No.: 17/455,616

(22) Filed: Nov. 18, 2021

(51) Int. Cl. G01C 21/34; G06K 9/00; H04N 5/247; G08G 1/01

(52) U.S. Cl. CPC G01C 21/3415; G06K 9/00785; H04N 5/247; G08G 1/0137; G06K 2209/23

(57) ABSTRACT

Aspects of the present disclosure include methods, systems, and non-transitory computer readable media for receiving a plurality of images of a plurality of street locations from a plurality of image capturing devices, identifying an event at a street location of the plurality of street locations based on one or more of the plurality of images, determining at least one new route for at least one vehicle based on the event and one or more of the plurality of images, and transmitting at least one indication indicating the at least one new route to at least one receiving device.

### TECHNICAL FIELD

Aspects of the present disclosure relate to implementing integrated image sensors for traffic control and monitoring.

### BACKGROUND

In some environments, vehicle and pedestrian traffic may cause obstructions in a transportation infrastructure. For example, traffic collisions, road constructions, and/or broken down vehicles may cause such traffic obstructions. While emergency personnel may assist in reducing the obstructions (e.g., police redirecting traffic), such countermeasures may be labor intensive. Further, when traffic obstructions build up on one road, other roads may experience obstructions as vehicles get blocked or diverted. Therefore, improvements may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include methods, systems, and non-transitory computer readable media for receiving a plurality of images of a plurality of street locations from a plurality of image capturing devices, identifying an event at a street location of the plurality of street locations based on one or more of the plurality of images, determining at least one new route for at least one vehicle based on the event and one or more of the plurality of images, and transmitting at least one indication indicating the at least one new route to at least one receiving device.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for implementing integrated image sensors for traffic monitoring and control in accordance with aspects of the present disclosure;

FIG. 2 illustrates an example method for implementing integrated image sensors for traffic monitoring and control in accordance with aspects of the present disclosure; and

FIG. 3 illustrates an example of a computer system in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

Aspects of the present disclosure may include a system that monitors and controls traffic via a controller and cameras. The system detects an event (such as a traffic collision, stalled vehicle, construction, etc.) based on the images captured by the cameras, and reroutes traffic around and/or away from the event. For example, the system may control traffic lights to reroute the traffic by changing the light patterns (e.g., extending the green light to allow vehicles to reroute around the event). The system may direct emergency vehicles toward the event to assist with any injuries, hazards, etc. In some aspects, the system may detect suspect vehicles (e.g., vehicles used in child abduction) based on the images captured by the cameras. In some instances, the controller may be integrated into one or more of the cameras.

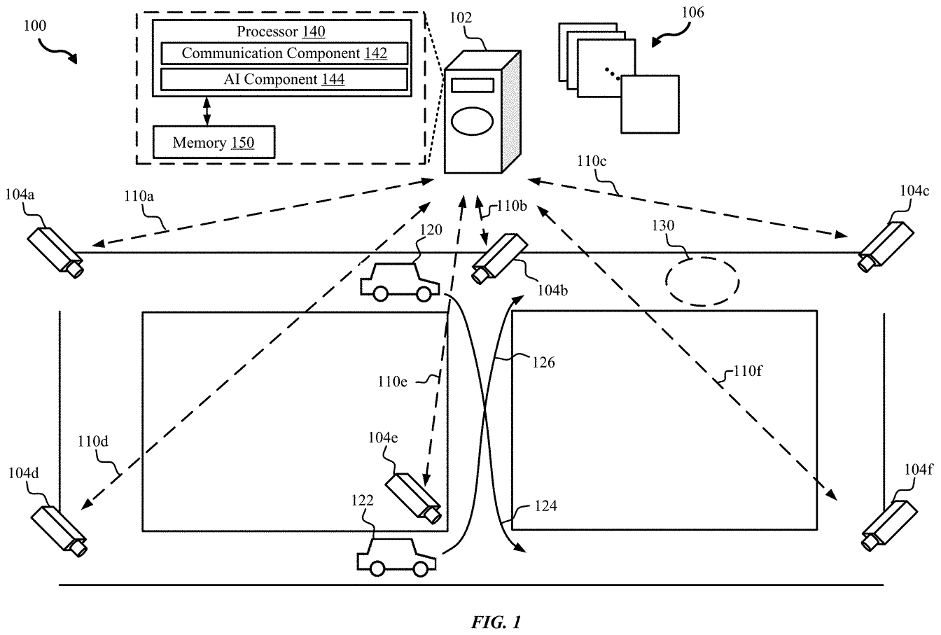

Referring to FIG. 1, in an aspect of the present disclosure, an example of an environment 100 for monitoring and/or controlling traffic is shown according to aspects of the present disclosure. The environment 100 may include a controller 102 configured to monitor and/or control traffic. The environment 100 may include image capturing devices 104a-f configured to capture images and/or videos of street locations. The image capturing devices 104a-f may include cameras, video recorders, etc. The image capturing devices 104a-f may be deployed at intersections or other locations along or near streets. The controller 102 may include a processor 140 that executes instructions stored in a memory 150 for performing the functions described herein.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, controllers, digital signal processors (DSPs), field programmable gate arrays (FPGAs), programmable logic devices (PLDs), state machines, gated logic, discrete hardware circuits, and other suitable hardware configured to perform the various functionality described herein.

In some aspects, the controller 102 may include memory 150. The memory 150 may include software instructions and/or hardware instructions. The processor 140 may execute the instructions to implement aspects of the present disclosure.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In certain aspects, the processor 140 may include a communication component 142 configured to communicate with the image capturing devices 104a-f and/or other external devices (not shown). The processor 140 may include an artificial intelligence (AI) component 144 configured to analyze captured images and/or determine routes based on the captured images.

During operation, in certain aspects, the image capturing devices 104a-f may be deployed along street locations being monitored by the image capturing devices 104a-f. For example, the image capturing devices 104a-f may be deployed on traffic lights, street lamps, buildings, or other suitable infrastructures. The image capturing devices 104a-f may capture images 106 of the street locations. The images 106 may be still images and/or videos. The image capturing devices 104a-f may transmit the captured images 106 to the controller 102 via communication channels 110a-f. The communication channels 110a-f may be wired and/or wireless communication links.

In some aspects, the communication component 142 of the controller 102 may receive the images 106 captured by the image capturing devices 104a-f. The AI component 144 of the controller 102 may analyze the images 106 to identify one or more events occurring in the street locations. The AI component 144 may be implemented using one or more of machine learning algorithms, convoluted neural networks, or other suitable mechanisms to monitor and/or control traffic according to aspects of the present disclosure. Examples of events may include one or more of a traffic collision, a road construction, a traffic congestion, an injured person, a hazard, and/or a broken-down vehicle. Based on the identified one or more events and/or the images 106, the AI component 144 of the controller 102 may generate one or more new routes for one or more vehicles at the street locations. The one or more new routes may direct the one or more vehicles away, around, or toward the events. The communication component 142 of the controller 102 may transmit the one or more new routes to a receiving device for indicating to the one or more vehicles. For example, the communication component 142 may transmit indications to traffic lights to change light patterns (e.g., activating, deactivating, and/or extending certain traffic lights).

In a first example, the controller 102 may receive the images 106 from the image capturing devices 104a-f via the communication channels 110a-f. Based on the images 106, the AI component 144 may identify an event 130, such as a traffic collision. The AI component 144 may identify a vehicle 120 (e.g., a non-emergency service vehicle) heading toward the event 130. In response, the AI component 144 may determine a first route 124 that indicates a path leading the vehicle 120 away and/or around the event 130. The first route 124 may indicate a path that leads non-emergency service vehicles away from the event 130 to reduce and/or clear traffic congestion at or near (e.g., within 5 meters, 10 meters, 20 meters, or 50 meters) the event 130. The communication component 142 of the controller 102 may transmit an indication indicating the first route 124 to one or more traffic lights (not shown) to direct the vehicle 120 along the first route 124. The indication indicating the first route 124 may include light patterns for the one or more traffic lights to implement the first route 124. The indication indicating the first route 124 may include global positioning system coordinates of an origin and/or a destination. The indication indicating the first route 124 may include a list of directions to traverse the first route 124.

In alternative implementations, the communication component 142 may transmit an indication indicating the first route 124 to a first traffic light. The first traffic light may relate the indication to a second traffic light, and so forth and so on.

In a second example, the controller 102 may receive the images 106 from the image capturing devices 104a-f via the communication channels 110a-f. Based on the images 106, the AI component 144 may identify an event 130, such as a pedestrian struck by a vehicle. The AI component 144 may identify an emergency service vehicle 122 (e.g., such as an ambulance) summoned for the event 130. In response, the AI component 144 may determine a second route 126 that indicates a path leading the emergency service vehicle 122 toward the event 130. The second route 126 may assist a driver of the emergency service vehicle 122 to locate and/or reach the event 130. The communication component 142 of the controller 102 may transmit an indication signal indicating the second route 126 to a global positioning system (GPS) in the emergency service vehicle 122 to direct the driver of the emergency service vehicle 122 to the event 130.

In a third example, the controller 102 may receive the images 106 from the image capturing devices 104a-f via the communication channels 110a-f. The controller 102 may receive a vehicle identification (e.g., a make, a model, a license plate number, etc.) of a suspect vehicle associated with a potential kidnapping and/or a missing person. Based on the images 106, the AI component 144 may identify an event 130, such as the suspect vehicle. Further, the AI component 144 may identify an emergency service vehicle 122 (e.g., law enforcement vehicle) searching for the kidnapped victim and/or the missing person. In response, the AI component 144 may determine a second route 126 that indicates a path leading the emergency service vehicle 122 toward the event 130. The second route 126 may assist a driver (e.g., law enforcement officer) of the emergency service vehicle 122 to locate and/or reach the event 130. The communication component 142 of the controller 102 may transmit an indication signal indicating the second route 126 to an onboard computer in the emergency service vehicle 122 to direct the driver of the emergency service vehicle 122 to the event 130. Additionally or alternative, the communication component 142 may transmit an notification to the onboard computer including the second route 126, the vehicle description of the suspect vehicle, a victim description, etc.

In some aspects of the present disclosure, the controller 102 and/or the AI component 144 may include image recognition algorithms to perform license plate recognition, vehicle identification, and/or facial recognition.

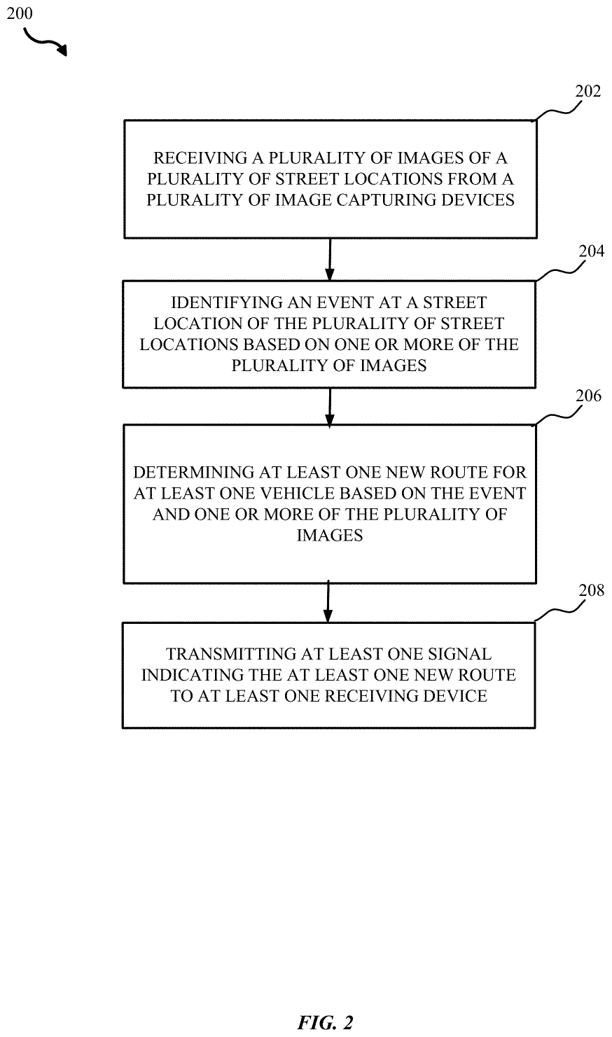

Turning to FIG. 2, an example of a method 200 for monitoring and/or controlling traffic may be implemented by the controller 102, the image capturing devices 104a-f, the processor 140, the communication component 142, the AI component 144, and/or the memory 150. One or more of the controller 102, the image capturing devices 104a-f, the processor 140, the communication component 142, the AI component 144, and/or the memory 150 may be configured to or provide means for implementing aspects of the method 200.

At block 202, the method 200 may receive a plurality of images of a plurality of street locations from a plurality of image capturing devices. The controller 102, the image capturing devices 104a-f, the processor 140, the communication component 142, and/or the memory 150 may be configured to or provide means for receiving a plurality of images of a plurality of street locations from a plurality of image capturing devices.

At block 204, the method 200 may identify an event at a street location of the plurality of street locations based on one or more of the plurality of images. The controller 102, the AI component 144, and/or the memory 150 may be configured to or provide means for identifying an event at a street location of the plurality of street locations based on one or more of the plurality of images.

At block 206, the method 200 may determine at least one new route for at least one vehicle based on the event and one or more of the plurality of images. The controller 102, the AI component 144, and/or the memory 150 may be configured to or provide means for determining at least one new route for at least one vehicle based on the event and one or more of the plurality of images.

At block 208, the method 200 may transmit at least one indication indicating the at least one new route to at least one receiving device. The controller 102, the processor 140, the communication component 142, and/or the memory 150 may be configured to or provide means for transmitting at least one indication indicating the at least one new route to at least one receiving device.

Aspects of the present disclosure includes the method above, wherein the event includes one or more of a traffic collision, a road construction, a traffic congestion, an injured person, a hazard, and/or a broken-down vehicle.

Aspects of the present disclosure includes any of the methods above, wherein the at least one new route indicates a path leading the at least one vehicle around or away from the event.

Aspects of the present disclosure includes any of the methods above, wherein transmitting the at least one indication comprises transmitting a plurality of signals to a plurality of traffic lights to direct the at least one vehicle around or away from the event. The controller 102, the processor 140, the communication component 142, and/or the memory 150 may be configured to or provide means for transmitting the at least one indication.

Aspects of the present disclosure includes any of the methods above, further comprising identifying an emergency vehicle based on at least an image of the plurality of images, wherein the at least one new route indicates a path leading the emergency vehicle toward the event. The controller 102, the AI component 144, and/or the memory 150 may be configured to or provide means for identifying the emergency vehicle.

Aspects of the present disclosure includes any of the methods above, further comprising receiving a suspect vehicle identification of a suspect vehicle associated one or more of a kidnapping or a missing person alert, wherein identifying the event includes identifying the suspect vehicle based on the suspect vehicle identification identified in the one or more of the plurality of images. The controller 102, the processor 140, the communication component 142, the AI component 144, and/or the memory 150 may be configured to or provide means for receiving the suspect vehicle identification and/or identifying the suspect vehicle.

Aspects of the present disclosure includes any of the methods above, further comprising notifying a law enforcement agency.

Aspects of the present disclosure includes any of the methods above, further comprising identifying an emergency vehicle based on at least an image of the plurality of images, wherein the at least one new route indicates a path leading the emergency vehicle toward the event. The controller 102, the processor 140, the AI component 144, and/or the memory 150 may be configured to or provide means for identifying the emergency vehicle.

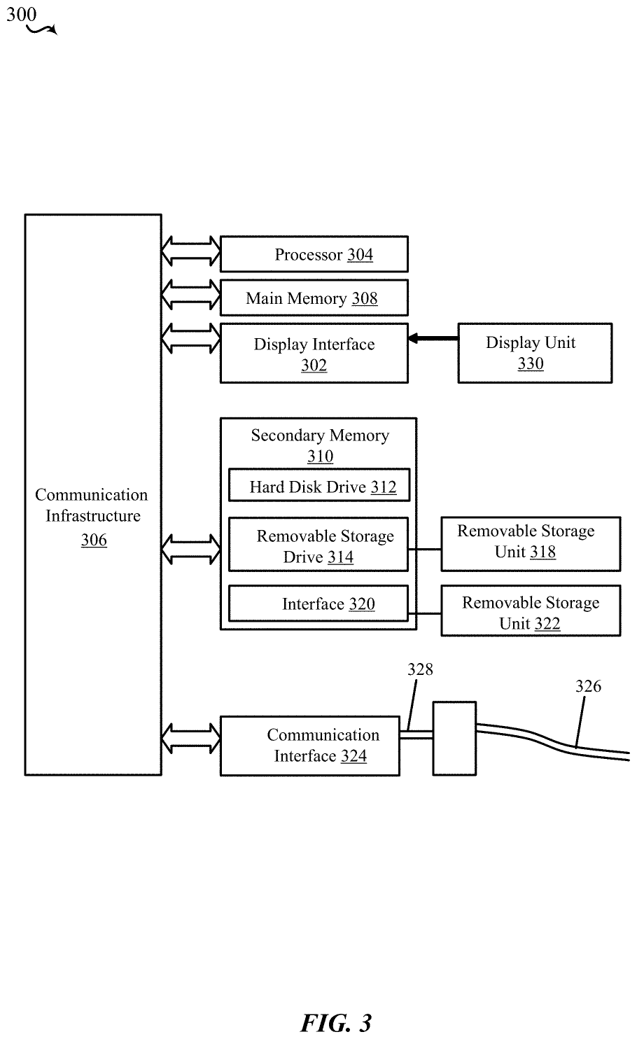

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 300 is shown in FIG. 3. In some examples, the controller 102 and/or the image capturing devices 104a-f may be implemented as the computer system 300 shown in FIG. 3. The controller 102 and/or the image capturing devices 104a-f may include some or all of the components of the computer system 300.

The computer system 300 includes one or more processors, such as processor 304. The processor 304 is connected with a communication infrastructure 306 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 300 may include a display interface 302 that forwards graphics, text, and other data from the communication infrastructure 306 (or from a frame buffer not shown) for display on a display unit 330. Computer system 300 also includes a main memory 308, preferably random access memory (RAM), and may also include a secondary memory 310. The secondary memory 310 may include, for example, a hard disk drive 312, and/or a removable storage drive 314, representing a floppy disk drive, a magnetic tape drive, an optical disk drive, a universal serial bus (USB) flash drive, etc. The removable storage drive 314 reads from and/or writes to a removable storage unit 318 in a well-known manner. Removable storage unit 318 represents a floppy disk, magnetic tape, optical disk, USB flash drive etc., which is read by and written to removable storage drive 314. As will be appreciated, the removable storage unit 318 includes a computer usable storage medium having stored therein computer software and/or data. In some examples, one or more of the main memory 308, the secondary memory 310, the removable storage unit 318, and/or the removable storage unit 322 may be a non-transitory memory.

Alternative aspects of the present disclosures may include secondary memory 310 and may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and the removable storage unit 322 and the interface 320, which allow software and data to be transferred from the removable storage unit 322 to computer system 300.

Computer system 300 may also include a communications circuit 324. The communications circuit 324 may allow software and data to be transferred between computer system 300 and external devices. Examples of the communications circuit 324 may include a modem, a network interface (such as an Ethernet card), a communications port, a Personal Computer Memory Card International Association (PCMCIA) slot and card, etc. Software and data transferred via the communications circuit 324 are in the form of signals 328, which may be electronic, electromagnetic, optical or other signals capable of being received by the communications circuit 324. These signals 328 are provided to the communications circuit 324 via a communications path (e.g., channel) 326. This path 326 carries signals 328 and may be implemented using wire or cable, fiber optics, a telephone line, a cellular link, an RF link and/or other communications channels. In this document, the terms “computer program medium” and “computer usable medium” are used to refer generally to media such as the removable storage unit 318, a hard disk installed in hard disk drive 312, and signals 328. These computer program products provide software to the computer system 300. Aspects of the present disclosures are directed to such computer program products.

Computer programs (also referred to as computer control logic) are stored in main memory 308 and/or secondary memory 310. Computer programs may also be received via communications circuit 324. Such computer programs, when executed, enable the computer system 300 to perform the features in accordance with aspects of the present disclosures, as discussed herein. In particular, the computer programs, when executed, enable the processor 304 to perform the features in accordance with aspects of the present disclosures. Accordingly, such computer programs represent controllers of the computer system 300.

In an aspect of the present disclosures where the method is implemented using software, the software may be stored in a computer program product and loaded into computer system 300 using removable storage drive 314, hard disk drive 312, or the interface 320. The control logic (software), when executed by the processor 304, causes the processor 304 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method for controlling traffic, comprising:
receiving a plurality of images of a plurality of street locations from a plurality of image capturing devices;
identifying an event at a street location of the plurality of street locations based on one or more of the plurality of images;
determining at least one new route for at least one vehicle based on the event and one or more of the plurality of images; and
transmitting at least one indication indicating the at least one new route to at least one receiving device.

2. The method of claim 1, wherein the event includes one or more of a traffic collision, a road construction, a traffic congestion, an injured person, a hazard, and/or a broken-down vehicle.

3. The method of claim 2, wherein the at least one new route indicates a path leading the at least one vehicle around or away from the event.

4. The method of claim 3, wherein transmitting the at least one indication comprises transmitting a plurality of indications to a plurality of traffic lights to direct the at least one vehicle around or away from the event.

5. The method of claim 2, further comprising identifying an emergency vehicle based on at least an image of the plurality of images;
wherein the at least one new route indicates a path leading the emergency vehicle toward the event.

6. The method of claim 1, further comprising:
receiving a suspect vehicle identification of a suspect vehicle associated one or more of a kidnapping or a missing person alert;
wherein identifying the event includes identifying the suspect vehicle based on the suspect vehicle identification identified in the one or more of the plurality of images.

7. The method of claim 6, further comprising identifying an emergency vehicle based on at least an image of the plurality of images;
wherein the at least one new route indicates a path leading the emergency vehicle toward the event.

8. The method of claim 6, further comprising transmitting a message indicating the street location of the suspect vehicle.

9. A controller, comprising:
a memory including instructions; and
a processor communicatively coupled to the memory and configured to execute the instructions to:
receive a plurality of images of a plurality of street locations from a plurality of image capturing devices;
identify an event at a street location of the plurality of street locations based on one or more of the plurality of images;
determine at least one new route for at least one vehicle based on the event and one or more of the plurality of images; and
transmit at least one indication indicating the at least one new route to at least one receiving device.

10. The controller of claim 9, wherein the event includes one or more of a traffic collision, a road construction, a traffic congestion, an injured person, a hazard, and/or a broken-down vehicle.

11. The controller of claim 10, wherein the at least one new route indicates a path leading the at least one vehicle around or away from the event.

12. The controller of claim 11, wherein transmitting the at least one indication comprises transmitting a plurality of signals to a plurality of traffic lights to direct the at least one vehicle around or away from the event.

13. The controller of claim 10, wherein:
the processor is further configured to identify an emergency vehicle based on at least an image of the plurality of images; and
the at least one new route indicates a path leading the emergency vehicle toward the event.

14. The controller of claim 9, wherein:
the processor is further configured to receive a suspect vehicle identification of a suspect vehicle associated one or more of a kidnapping or a missing person alert;
wherein identifying the event includes identifying the suspect vehicle based on the suspect vehicle identification identified in the one or more of the plurality of images.

15. The controller of claim 14, wherein:
the processor is further configured to identify an emergency vehicle based on at least an image of the plurality of images;
wherein the at least one new route indicates a path leading the emergency vehicle toward the event.

16. The controller of claim 14, wherein the processor is further configured to transmit a message indicating the street location of the suspect vehicle.

17. A non-transitory computer readable medium including instructions that, when executed by a processor of a controller, cause the processor to:
receive a plurality of images of a plurality of street locations from a plurality of image capturing devices;
identify an event at a street location of the plurality of street locations based on one or more of the plurality of images;
determine at least one new route for at least one vehicle based on the event and one or more of the plurality of images; and
transmit at least one indication indicating the at least one new route to at least one receiving device.

18. The non-transitory computer readable medium of claim 17, wherein the event includes one or more of a traffic collision, a road construction, a traffic congestion, an injured person, a hazard, and/or a broken-down vehicle.

19. The non-transitory computer readable medium of claim of claim 18, wherein the at least one new route indicates a path leading the at least one vehicle around or away from the event.

20. The non-transitory computer readable medium of claim of claim 19, wherein the instructions for transmitting the at least one indication comprises instructions for transmitting a plurality of signals to a plurality of traffic lights to direct the at least one vehicle around or away from the event.

21. The non-transitory computer readable medium of claim of claim 18, further comprising instructions for identifying an emergency vehicle based on at least an image of the plurality of images; and
wherein the at least one new route indicates a path leading the emergency vehicle toward the event.

22. The non-transitory computer readable medium of claim of claim 17, further comprising instructions for receiving a suspect vehicle identification of a suspect vehicle associated one or more of a kidnapping or a missing person alert; and
wherein the instructions for identifying the event includes instructions for identifying the suspect vehicle based on the suspect vehicle identification identified in the one or more of the plurality of images.

23. The non-transitory computer readable medium of claim 22, further comprising instructions for identifying an emergency vehicle based on at least an image of the plurality of images;
wherein the at least one new route indicates a path leading the emergency vehicle toward the event.

24. The non-transitory computer readable medium of claim 22, further comprising instructions for transmitting a message indicating the street location of the suspect vehicle.
